(19) United States
(12) Patent Application Publication
(10) Pub. No.: US 2011/0028266 A1
(43) Pub. Date: Feb. 3, 2011

(54) Bearing Arrangement and Mounted Component for a Differential Gear Mechanism

(75) Inventors: Thomas Friedrich, Hausen (DE); Wolfgang Husslein, Gerolzhofen (DE); Udo Krug, Theres (DE)

Correspondence Address: SKF USA Inc., 890 Forty Foot Road, PO Box 352, Lansdale, PA, 19446, US

(73) Assignee: AKTIEBOLAGET SKF, Goteborg (SE)

(21) Appl. No.: 12/827,179

(22) Filed: Jun. 30, 2010

(30) Foreign Application Priority Data
Jun. 30, 2009 (DE) 10 2009 031 068.1

(51) Int. Cl. F16H 57/08; F16C 33/58

(52) U.S. Cl. 475/331; 384/571

(57) ABSTRACT

A bearing arrangement has at least two anti-friction bearings which are spaced apart along a central axis. At least one bearing is configured as a tapered roller bearing, the tapered roller bearing having a number of frustoconical rolling bodies. A cone angle between a line of symmetry of each rolling body and the central axis is between 20° and 33°.

### CROSS-REFERENCE TO RELATED APPLICATIONS

This application claims priority to German patent application no. 10 2009 031 068.1, filed on Jun. 30, 2009, which is incorporated fully herein by reference.

### BACKGROUND OF THE INVENTION

The present invention generally relates to bearings and bearing assemblies, which may preferably be utilized in wheel bearings, e.g., truck wheel bearings, in certain applications of the present teachings.

The present invention relates to a bearing arrangement having at least two anti-friction bearings which are spaced apart axially and of which at least one is configured as a tapered roller bearing, the tapered roller bearing having a number of frustoconical rolling bodies. Furthermore, the invention relates to a mounted component for a differential gear mechanism.

Bearing arrangements as discussed above are known and often used in the automotive sector. They are used, for example, in wheel bearings or for mounting shafts of the differential gear mechanism. In the application-related design of the tapered roller bearings, the critical factor is the selection of what is known as the cone angle. This cone angle denotes the angle between an imaginary line of symmetry of the frustoconical rolling bodies and the axial direction of the bearing arrangement, i.e., the centerline of the bearing assembly. In particular, the load rating of the tapered roller bearings depends on the selected cone angle of the mounting.

During the use of anti-friction bearings in general, it is to be noted in the range of high speeds that undesired heating of the components of the mounting can occur. This has a negative effect, in particular, on the temperature of the lubricant used for the mounting. If central lubricating systems are used for continuously ensuring the lubrication of a plurality of bearings in a vehicle, the required cooling performance for the lubricant is likewise increased in the case of increased heat dissipation by the bearings.

### SUMMARY OF THE INVENTION

It is an object of the present invention to provide a particularly low-friction bearing arrangement and a mounted component for a differential gear mechanism which is designed for high speeds.

This object is achieved by a bearing arrangement having the features of claim 1 and a component having the features of claim 7. Advantageous refinements are the subject matter of the respectively dependent claims.

In one aspect of the present invention, a bearing arrangement is specified having at least two anti-friction bearings which are spaced apart axially and of which at least one is configured as a tapered roller bearing, the tapered roller bearing having a number of frustoconical rolling bodies. The cone angle A of the rolling bodies is between 20° and 33°.

In known tapered roller bearings, the cone angle was 20° or less, in particular in the automotive sector. However, it has been shown urprisingly that, in the case of the cone angle being increased into the range from 20° to 33°, a considerable reduction in the friction which occurs in the bearing is possible. This leads to a reduced development of heat during operation of the bearing arrangement, with the result that, in particular, the cooling outlay for a lubricant is reduced considerably. The second anti-friction bearing serves as a counterbearing to the mainly loaded tapered roller bearing and can be configured, for example, as a tapered roller bearing, angular-contact ball bearing, axial cylindrical roller bearing, axial deep-groove ball bearing or radial deep-groove ball bearing. The selection is determined depending on the application of the bearing arrangement under the selected use conditions according to loading and required speed.

In one advantageous refinement of the invention, a further tapered roller bearing is provided and the tapered roller bearings are arranged in an O-arrangement. This type of arrangement of the tapered roller bearings is to be found frequently, in particular, in the automotive sector. The name arises from the fact that, in a sectional view of the bearing, imaginary lines through the four pressure points of the four visible rolling bodies (two per bearing) form a rhombus with their running faces if extended, which rhombus can be considered to be a diagrammatic O. In contrast, it is likewise possible to arrange two tapered roller bearings in what is known as the X-arrangement, that is to say in a precisely inverted way. It has been shown that the cone angle A of from 20° to 33° is advantageous, in particular, in the case of tapered roller bearings in an O-arrangement and leads to particularly reduced friction.

The cone angle A_{C} is ideally 24° 12″. In the case of this cone angle, the reduction of the friction in the bearing is at a maximum. A particularly great reduction in the development of heat in the bearing arrangement can therefore be achieved with this cone angle A_{C} of 24° 12″, in particular.

In order to reduce the friction in the bearing arrangement further, it is possible to reduce the number of rolling bodies used in each of the tapered roller bearings. According to one preferred embodiment of the invention, the number of rolling bodies of each of the tapered roller bearings, rounded as an integer, is in each case between 60 and 90%, preferably from 70 to 75%, particularly preferably 73% of the full-rollered fitting. Here, however, a compromise has to be found with respect to the then reduced load rating of the tapered roller bearing. In the case of known embodiments of bearing arrangements of this type which are used, for example, in differential gear mechanisms, the number usually used in the case of a bearing diameter of 120 mm is 37 rolling bodies. According to the preferred embodiment of the invention, the number of rolling bodies is then 27. In the case of a bearing arrangement with corresponding tapered roller bearings with a cone angle A_{C} of 24° 12″ and a 73% fitting with rolling bodies, the friction can be reduced by over 40% with respect to known bearings.

In another aspect, the present invention is also a mounted component for a differential gear mechanism, which includes a shaft with a “toothing” system (i.e., a set of gear teeth engageable with complementary teeth) on an end side or end, the component having a bearing arrangement to mount it rotatably. The bearing arrangement is configured as a bearing arrangement according to one of claims 1 to 6. The bearing arrangement according to the invention can thus be used particularly advantageously in differential gear mechanisms as a result of the reduced friction, where, in particular if the speed is increased, higher speeds and therefore a greater development of heat are produced. It is to be noted in each case during the optimization for the installation situation that the load rating of the bearing arrangement is reduced by the increased cone angle and the reduced number of rollers.

Alternative areas of application for the bearing arrangement according to the invention are, for example, wheel bearings and screw drives.

### BRIEF DESCRIPTION OF THE DRAWING

The foregoing summary, as well as the detailed description of the preferred embodiments of the present invention, will be better understood when read in conjunction with the appended drawing. For the purpose of illustrating the invention, there is shown in the drawing, which is diagrammatic, an embodiment that is presently preferred. It should be understood, however, that the present invention is not limited to the precise arrangements and instrumentalities shown. In the drawing:

FIG. 1 is an axial cross-sectional view through a differential gear mechanism including a bearing arrangement of the present invention.

### DETAILED DESCRIPTION OF THE INVENTION

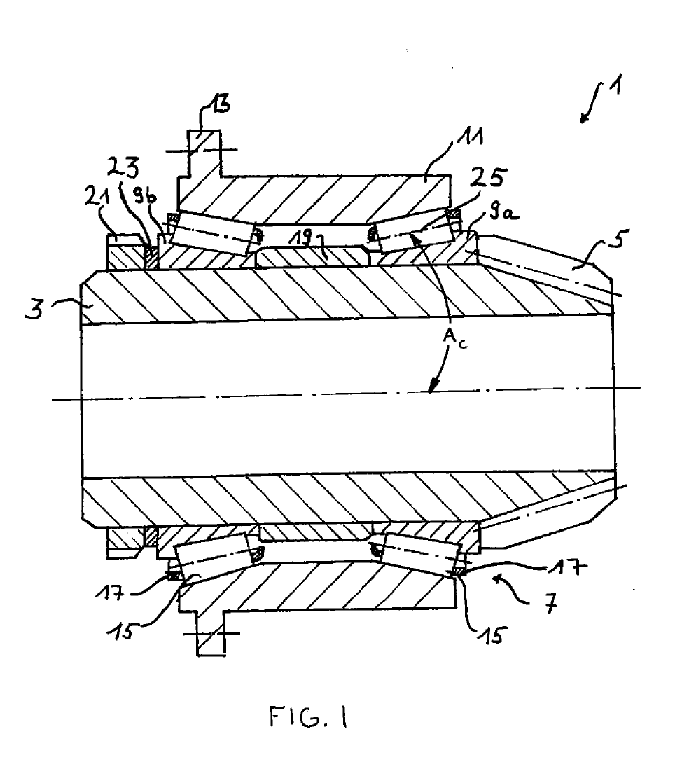

FIG. 1 shows a differential gear 1 of a differential gear mechanism as an exemplary embodiment of the invention. The differential gear 1 encloses a shaft 3 with opposing axial ends, and an obliquely extending “toothing system” 5 is disposed or arranged on one end. The shaft 3 can be formed as a solid shaft or as a hollow shaft. The obliquely running toothing system 5, which includes a plurality of circumferentially spaced gear teeth (not indicated), is preferably integrally formed with the shaft 3 such that the shaft 3 and toothing system 5 are of “one piece” construction. The toothing system interacts in the differential gear mechanism with comparably obliquely configured toothing systems of two axle shafts.

In order to function in the differential gear mechanism, the shaft 3 has to be mounted rotatably. It is therefore mounted rotatably in a housing (not shown) by means of a bearing arrangement 7. The bearing arrangement 7 has two tapered roller bearings which each have an inner ring 9a and 9b. In addition, both tapered roller bearings have a common outer ring 11. A flange-like projection 13, by means of which the outer ring 11 can be fastened to a housing (not shown) of the differential gear mechanism, is attached to the outer ring 11. The inner rings 9a and 9b have running faces for tapered rollers 15. The outer ring 11 has running faces which correspond thereto. The shaft 3 is mounted rotatably via the rolling bodies 15 and the inner rings 9a and 9b with respect to the outer ring 11 and therefore with respect to the housing which is connected to it. The rolling bodies 15 are guided in each case in a cage 17. An intermediate ring 19 is arranged or disposed on the shaft 3 between the inner rings 9a and 9b. The intermediate ring 19 serves for spacing apart the inner rings 9a and 9b and therefore the two tapered roller bearings axially in a defined manner, it therefore being possible to mount the latter easily. In addition, the intermediate ring 19 serves to fix the axial clamping force of the two inner rings 9a and 9b.

In order to secure the bearing arrangement 7 axially, the inner ring 9a butts axially against the toothing system 5. This results in an advantage on account of the integral configuration with the shaft 3. A clamping nut 21 for axial fixing is provided on the opposite side of the shaft 3. A clamping ring 23 is arranged between the clamping nut 21 and the inner ring 9b.

In each case an imaginary line of symmetry 25 is shown by a dashed line through the tapered rollers 15 which are shown. The cone angle A_{c} between the line 25 and the axial direction of the shaft 3 is between 20 and 33°. The cone angle A_{C} is preferably 24° 12″. As a result, a significant reduction can be achieved in the friction which occurs in the bearing in comparison with known bearings with a cone angle of 20° or less.

The number of tapered rollers 15 used in comparison with a “full-rollered” fitting is reduced in order to further reduce the friction which occurs in the bearing. Rounded to an integer, it is 73% of the full-rollered state in the ideal case. In the case of a standard bearing which has, for example, 37 rollers in the case of a diameter of 120 mm, a bearing according to the invention would have only 27 tapered rollers. This allows a further reduction in the friction to be achieved. The cage 17 is correspondingly configured in such a way that it makes reliable guidance of the tapered rollers possible, without the latter being able to wander during the movement of the bearing. This is required, in particular, on account of the reduced number of rollers.

The differential gear 1 shown represents one preferred embodiment of the invention. The reduced-friction design of the bearing arrangement 7 can likewise be used, however, in other application areas outside differential gear mechanisms if a reduction in the heat produced is of advantage.

It has been shown that, in particular in the case of differential gear mechanisms at high speed in the order of magnitude of 5000 rpm, for example in the case of tractor or lorry differential gear mechanisms, a pronounced increase in the temperature was the result on account of the high friction in known tapered roller bearings. The lubricating oil for the tapered roller bearings which was often provided by a central lubricating unit in tractors, in particular, therefore had to be cooled with increased outlay. A significant reduction in the friction can be achieved by the design according to the invention of the bearing arrangement 7, with the result that up to 800 watts less thermal energy is produced per tapered roller bearing in the bearing arrangement 7. As a result, the cooling outlay for the lubricating oil is reduced significantly.

In an alternative exemplary embodiment, in order to achieve the advantage according to the invention, one of the tapered roller bearings can be replaced by another anti-friction bearing type, for example by an angular-contact ball bearing, axial cylindrical roller bearing, axial deep-groove ball bearing or radial deep-groove ball bearing. The selection is determined depending on the application of the bearing arrangement under the selected use conditions according to loading and required speed.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

We claim:

1. A bearing arrangement comprising at least two anti-friction bearings spaced apart along a central axis, at least one of the two bearings being configured as a tapered roller bearing, the tapered roller bearing having a plurality of frustoconical rolling bodies spaced circumferentially about the axis, each frustoconical rolling body being arranged such that a cone angle defined between a line of symmetry of the rolling body and the central axis is within the range of about 20° to about 33°.

2. The bearing arrangement as recited in claim 1, wherein each of the at least two bearings is configured as a tapered roller bearing, the two tapered roller bearings being arranged in an O-arrangement.

3. The bearing arrangement as recited in claim 1, wherein the cone angle of each frustoconical rolling body is about 24° 12″.

4. The bearing arrangement as recited in claim 1, wherein each of the two bearings has an inner ring with a running face for rolling bodies.

5. The bearing arrangement as recited in the two bearing inner rings is spaced apart axially and the bearing arrangement further comprises a generally annular intermediate ring disposed between the two bearing inner rings.

6. A component for a differential gear mechanism, the component comprising:
a shaft with opposing axial ends and a toothing system disposed at one of the ends; and
a bearing arrangement for rotatably mounting the shaft, the bearing arrangement including at least two anti-friction bearings spaced apart along a central axis, at least one of the two bearings being configured as a tapered roller bearing, the tapered roller bearing having a plurality of frustoconical rolling bodies spaced circumferentially about the axis, each frustoconical rolling body being arranged such that a cone angle defined between a line of symmetry of the rolling body and the central axis is within the range of about 20° to about 33°.

7. The component as recited in claim 6, wherein the toothing system is integrally formed with the shaft.

8. The component as recited in claim 6, wherein the toothing system forms an axial stop for an inner ring of one of the anti-friction bearings.

9. The component as recited in claim 8, further comprising a clamping nut disposed on the shaft proximal to the other one of the shaft ends such that the two anti-friction bearings are axially fixed between the nut and the toothing system.

10. The component as recited in claim 9, wherein an intermediate ring is arranged between the clamping nut and the adjacent inner ring.
